(19) United States
(12) Patent Application Publication
(10) Pub. No.: US 2019/0098876 A1
(43) Pub. Date: Apr. 4, 2019

(54) METHODS OF FEEDING BEES FEED PRODUCTS CONTAINING BLOOD MEAL

(71) Applicant: PURINA ANIMAL NUTRITION LLC, Shoreview, MN (US)

(72) Inventors: Grace Kunkel, Kirkwood, MO (US); Kent J. Lanter, Waterloo, IL (US); Bill L. Miller, Labadie, MO (US)

(21) Appl. No.: 15/724,750

(22) Filed: Oct. 4, 2017

(51) Int. Cl. A01K 51/00; A23K 50/90; A23K 20/147; A23K 20/10

(52) U.S. Cl. CPC A01K 51/00; A23K 20/10; A23K 20/147; A23K 50/90

(57) ABSTRACT

The present disclosure describes bee feed products containing blood meal making the products less susceptible to a beetle infestation, and methods of feeding such products to bees. Feeding methods may involve providing a bee feed product to bees on an ad libitum basis. The bee feed product can be an admixture of a liquid bee feed and an amount of blood meal. The amount of blood meal in the bee feed product may reduce the level of beetle infestation. In embodiments, the bees may increase consumption of the feed product in response to the reduced level of beetle infestation.

### CROSS-REFERENCE TO RELATED APPLICATIONS

This application is filed concurrently with an application entitled “BEE FEED PRODUCTS AND METHODS OF USING THE SAME” with docket number P258755.US.01; and with an application entitled “BEE FEED PRODUCTS AND METHODS OF MAKING AND USING SAME” with docket number P267399.US.01, each of which are herein incorporated by reference in their entirety.

### TECHNICAL FIELD

The present disclosure relates to bee feed products containing blood meal and methods of feeding the products to bees. Implementations prevent and/or reduce a level of beetle infestation in the bee feed products and bee colonies.

### BACKGROUND

Small hive beetles (“SHBs”) are a common pest associated with honey bees and beekeeping. Especially in high-moisture parts of the country, SHBs can proliferate extremely quickly and even kill weak bee colonies. The SHBs may overtake a colony by laying eggs that turn into thousands of larvae that destroy the comb in the colony through the process of looking for honey and bee bread to consume. The short life cycle of SHBs, maturing in seven to ten days, accelerates their ability to overwhelm a bee colony. By the time a beekeeper notices even one SHB, it may be too late to prevent mass infestation.

Another challenge to bee survival is overcoming inadequate nutrition. As the chief source of protein for most bees, insufficient pollen supplies often lead to diminished bee survival and reduced reproduction rates, causing bee colony size to rapidly diminish. A common solution implemented by beekeepers to counteract this problem is to provide bees with a protein supplement; however, beekeepers are often reluctant to utilize protein supplements due to their tendency to attract SHBs. By providing a substrate for the SHBs to lay eggs and develop, the supplements may foster beetle infestation and colonization. Bees typically consume much less, if any, of an infested feed composition, resulting in wasted feed, increased pest loads, decreased bee nutrition, potentially leading to bee death, and large monetary losses.

Beekeepers may thus be confronted with a catch-22: provide a protein supplement to address pollen shortages but risk SHB infestation, or minimize the risk of SHB infestation by refraining from providing a protein supplement at the cost of the colony's nutrition. Improved bee feed compositions are therefore needed to solve this dilemma by addressing shortages in natural protein without increasing the likelihood of SHB infestation.

### SUMMARY

In accordance with some examples of the present disclosure, a method of feeding bees may involve providing a bee feed product to the bees on an ad libitum basis, where the bee feed product is an admixture of blood meal and a liquid bee feed, where the amount of blood meal in the bee feed product reduces a level of beetle infestation.

In some examples, the bees may increase consumption of the bee feed product in response to the reduced level of beetle infestation. In some embodiments, the amount of blood meal may comprise about 10 wt % to about 50 wt % of the bee feed product. In some examples, the bee feed product may comprise about 10 wt % to about 40 wt % protein. In some embodiments, the bee feed product may comprise about 20 wt % to about 30 wt % protein. In some examples, the amount of blood meal may comprise about 50 wt % to about 100 wt % of a total protein content of the bee feed product. In some embodiments, the amount of blood meal may comprise about 90 wt % to about 100 wt % of a total protein content of the bee feed product. In some examples, the bee feed product may be free of one or more of a corn gluten meal, soy, and egg powder. In some embodiments, the bee feed product may comprise a patty. In some examples, the bees may be adult bees. In some embodiments, the bees may be newly-emerged bees.

In some examples, the level of beetle infestation may comprise an infestation of one or more small hive beetles after a period of about 24 hours. In some embodiments, the bee feed product may reduce a level of beetle infestation by one or more of: reducing a total number of beetles in the bee feed product compared to a preexisting feed composition lacking blood meal, preventing one or more beetles from infesting the bee feed product, reducing a number of beetle larvae in the bee feed product, reducing a number of beetle pupae in the bee feed product, or delaying an onset of a beetle infestation. In some examples, providing the bee feed product comprises offering a new allotment of the bee feed product to the bees every week.

In accordance with some examples of the present disclosure, a method of feeding a bee colony in an area accessible to small hive beetles may involve providing to the bee colony an amount of a bee feed product comprising nutrients including blood meal, where the bee colony has ad libitum access to ingest the bee feed product for a time period; where after the time period, the bee feed product is consumed by the colony to a greater extent and has a reduced level of beetle infestation compared to providing a bee colony with ad libitum access to the same amount of another bee feed product comprising the nutrients but which is free of blood meal. In some examples, the amount of the bee feed product may be one pound and the time period may be one week.

In accordance with some examples of the present disclosure, a bee feed product may include a bee feed liquid; an amount of blood meal; and a total protein content of about 10 to about 40 wt %, of which the amount of blood meal is a primary component by weight, where the bee feed product is less susceptible to a beetle infestation compared to bee feed products lacking the amount of blood meal.

In some embodiments, the amount of blood meal may comprise about 60 to about 100 wt % of the total protein content. In some examples, the bee feed product may further include one or more food components comprising at least one of a flour, yeast, one or more oils, and one or more sugars. In some embodiments, in response to being less susceptible to a beetle infestation, the bee feed product may contain a smaller number of one or more beetles, beetle larvae, or beetle pupae after about 48 hours of exposure in a feeding environment compared to a similar feed product lacking the amount of blood meal.

### DETAILED DESCRIPTION

Implementations provide bee feed products comprised of blood meal, and methods of feeding such feed products to bees. Despite having a form, texture, and overall nutritional content substantially similar to other bee feed products that do not contain blood meal, the feed products described herein may not attract, and may even deter, SHB infestation. In embodiments, the feed products of the present disclosure may contain high levels of protein to compensate for low pollen availability in the surrounding environment, and may thus be considered protein-rich feed products. Unlike preexisting protein products, however, blood meal may comprise the primary protein source in the feed products described herein. Accordingly, traditional protein sources may be absent or nearly absent from these newly developed bee feed products.

Providing blood meal to bee colonies in bee feed products may prevent SHBs from infesting the feed and/or reduce the number of SHBs in the feed over time, diminish SHB reproduction rates, slow or prevent SHB larval development, and/or diminish SHB survival. For example, when provided with a choice between preexisting feed products lacking blood meal and the feed products disclosed herein, SHBs may preferentially select the preexisting feed products for infestation instead of the feed products containing blood meal. In addition, or alternatively, SHB larvae placed on bee feed products containing blood meal may not survive or may be less likely to develop into pupae than SHB larvae placed onto feed products lacking blood meal.

Bee Feed Products

The bee feed products containing blood meal disclosed herein may include products formed into discrete product units, e.g., patties. Each patty may comprise blood meal and a liquid bee feed formed into a cohesive dough-like feed product with variable shape. As provided herein, the blood meal may provide nutrients to bees while providing a natural approach to deterring SHB infestation. In some embodiments, the feed products may comprise a dry, powder-like composition combined with an amount of blood meal and one or more liquids, e.g., syrup. The resulting feed products may also contain high levels of protein, and may thus be considered protein-rich products. When provided to bees according to the methods disclosed herein, the bee feed products may be less susceptible to, or may deter or prevent, beetle infestation. As a result, bees may consume greater amounts of the feed, thereby reducing feed waste. The high level of protein in the bee feed products may provide bees with adequate protein levels.

The blood used to form the blood meal may be captured as a byproduct of processing various animals, e.g., livestock or poultry. In addition or alternatively, the blood meal can be provided in various feed compositions and/or edible carriers. In some examples, the blood can be dried to form a powder before mixing with the other feed components and the liquid to form the final feed products. The blood meal may include one or more of the 10 amino acids essential to the honey bee diet, including but not limited to: methionine, tryptophan, arginine, lysine, histidine, phenylalanine, isoleucine, threonine, leucine and valine.

In some embodiments, the blood meal content of the final product may range from about 10 wt % to about 50 wt %, about 10 wt % to about 45 wt %, about 10 wt % to about 40 wt %, about 10 wt % to about 20 wt %, about 15 wt % to about 20 wt %, about 16 wt % to about 18 wt %, about 15 wt % to about 35 wt %, about 20 wt % to about 30 wt %, about 22 wt % to about 28 wt %, about 22 wt % to about 26 wt %, about 25 wt % to about 30 wt %, about 25 wt % to about 27 wt %, about 18 wt % to about 24 wt %, or about 20 wt % to about 22 wt %, or up to about 10, 15, 20, 25, 30, 35, 40, 45 or 50 wt %. The ratio of blood meal to the remainder of the feed product may vary, ranging from about 0.4, 0.5, 0.6, 0.7, 0.8, 0.9, or 1.0 parts blood meal to about 1.0, 1.1, 1.2, 1.3, 1.4, 1.5, 1.6, 1.7, 1.8, 1.9, or 2.0 parts feed product. For instance, the ratio of blood meal to the remainder of the product may be 0.4:1.5 to 0.4:1.9.

Blood meal contributes to the protein content of each feed product. In various embodiments, blood meal may comprise the majority, by weight, of the protein in the feed product, such that the blood meal comprises greater than 50 wt % of the total protein content. In other examples, blood meal may comprise the entire protein content of the product. In some examples, the blood meal content of the total protein may range from about 50 wt % to about 100 wt %, about 50 wt % to about 60 wt %, about 55 wt % to about 60 wt %, about 60 wt % to about 100 wt %, about 65 wt % to about 75 wt %, about 70 wt % to about 75 wt %, about 70 wt % to about 100 wt %, about 80 wt % to about 100 wt %, or about 90 wt % to about 100 wt % of the total protein.

In some examples, the high protein levels that can be included in the feed products may compensate for low pollen availability in the bees' environment. The protein content may vary in embodiments, depending on whether the feed products serve to supplement or substitute natural pollen, as pollen substitutes may contain higher levels of protein than protein supplements. In some embodiments, the total protein content of the feed products may range from about 10 wt % to about 50 wt %, about 15 wt % to about 40 wt %, about 30 wt % to about 40 wt %, about 20 wt % to about 30 wt %, about 22 wt % to about 26 wt %, or about 23 wt % to about 25 wt %.

In various embodiments, the bee feed products may be free or substantially free of traditional protein sources, which may comprise the primary protein components of preexisting feed compositions and protein supplements. Traditional protein sources excluded from the feed products in some examples may include corn gluten meal, soy or soy products, and/or egg powder. In other examples, the bee feed products may contain one or more of corn gluten meal, soy, and egg powder. In such embodiments, blood meal may still comprise the primary protein source by weight of the total protein content. For instance, embodiments may include corn gluten meal, soy, and/or egg powder in amounts ranging from about 1 wt % to about 20 wt %, about 5 wt % to about 15 wt %, about 8 wt % to about 12 wt %, or about 5 wt % to about 10 wt % of the total protein content.

The feed products may contain various feed components in addition to blood meal. Yeast, for example, may be included. Various types of yeast, e.g., brewer's yeast, baker's yeast, grain distillers dried yeast, and/or torula yeast, may be used. The amount of yeast may vary in different implementations, ranging from about 5 wt % to about 30 wt %, about 10 wt % to about 25 wt %, about 15 wt % to about 20 wt %, or about 18 wt % to about 20 wt % of each feed product. Additional feed components may include, for example, various carbohydrates, including various types of flour, e.g., canola flour, sunflower flour, sorghum flour, wheat flour, and/or triticale flour.

The liquid used to form each feed product may include one or more sugar-based carbohydrates. Sugar-based carbohydrates may be high in sucrose and may include, for example, honey, syrup, corn syrup, liquid sucrose, fructose, and/or molasses. Sugar-based carbohydrates may be defined as liquid bee feeds. In addition to sugar-based carbohydrates, liquid bee feeds may contain additional feed components including those provided herein.

The volume of liquid included in each product may vary and may depend on the desired form and viscosity of the feed products. For example, to form a feed patty, which is a dough-like material formed as a single mass, various feed components including blood meal, may be mixed with the liquid at a ratio of about 1.0 part feed to about 1.0, 1.1, 1.2, 1.3, 1.4, 1.5, 1.6, 1.7, 1.8, 1.9, or 2.0 parts liquid. After mixing the liquid with the feed components, the mixture may be formed into a patty. The liquid content of the resulting patty may range from about 20 wt % to about 70 wt %, about 30 wt % to about 65 wt %, about 40 wt % to about 60 wt %, or about 45 wt % to about 55 wt %. In various embodiments, the ratio of blood meal to liquid in the resulting patty may range from about 0.3 parts blood meal to about 1.0 parts liquid, about 0.3 parts blood meal to about 1.3 parts liquid, about 0.3 parts blood meal to about 1.5 parts liquid, about 0.4 parts blood meal to about 1.0 parts liquid, about 0.4 parts blood meal to about 1.3 parts liquid, about 0.4 parts blood meal to about 1.5 parts liquid, about 0.5 parts blood meal to about 1.0 parts liquid, about 0.5 parts blood meal to about 1.3 parts liquid, about 0.5 parts blood meal to about 1.5 parts liquid, about 0.6 parts blood meal to about 1.0 parts liquid, about 0.6 parts blood meal to about 1.3 parts liquid, about 0.6 parts blood meal to about 1.5 parts liquid, about 0.8 parts blood meal to about 1.0 parts liquid, about 0.8 parts blood meal to about 1.3 parts liquid, about 0.8 parts blood meal to about 1.5 parts liquid, about 1.0 parts blood meal to about 1.0 parts liquid, about 1.0 parts blood meal to about 1.3 parts liquid, about 1.0 parts blood meal to about 1.5 parts liquid.

In embodiments, the feed products may be formed into patties, however, the particular form of the feed products may vary. When formed into patties, these may be shaped as discs, blocks, cakes or biscuits, for example. In some embodiments, the patties or other feed products may not be formed into discrete shapes, but rather provided to bees in unformed states. The texture of the final products may be mealy and granulated. In some examples, the form of the bee feed products may be adjusted to accommodate changing nutritional needs. For instance, where increased moisture levels are needed, water may be added such that the density and/or viscosity of the feed product is reduced.

Feed patties formed in accordance with the present disclosure may vary in size according to the level of protein needed, the number of bees fed, and/or the size of the feeding area. In some examples, the patties may weigh about 1 lb. each. In other embodiments, each patty may weigh about 0.1 lbs. to about 10 lbs., about 0.1 lbs. to about 8 lbs., about 0.1 lbs. to about 6 lbs., about 0.1 lbs. to about 4 lbs., about 0.1 lbs. to about 2 lbs., about 0.25 lbs. to about 1.75 lbs., about 0.5 lbs. to about 1.5 lbs., or about 0.75 lbs. to about 1.25 lbs., up to about 4 lbs., about 3 lbs., about 2 lbs., about 1 lbs., about 0.75 lbs., about 0.5 lbs., about 0.25 lbs., or about 0.1 lbs. The thickness of the patties may also vary widely and may depend on the dimensions of the feeding apparatus and/or the moisture content of the patties. In some examples, the patties may have a thickness ranging from about 5 mm to about 10 cm, about 5 mm to about 8 cm, about 5 mm to about 6 cm, about 5 mm to about 4 cm, about 5 mm to about 3 cm, about 5 mm to about 2 cm, about 5 mm to about 1.5 cm, or about 5 mm to about 1 cm, or up to about 5 cm, about 4 cm, about 3 cm, about 2 cm, about 1 cm, or about 0.5 cm although any weight and/or thickness may be implemented in accordance with the present disclosure.

The feed products may be formulated specifically for bees having little or no access to pollen. For example, the feed products described herein may be particularly well-suited for honey bees having no access to forage.

Methods of Feeding Bees

Methods of feeding bees may involve providing the bees with feed products containing blood meal. In some implementations, the feed products may be high in protein and provided to bees to increase their protein intake. When provided to the bees, the bee feed products may prevent, reduce, eliminate, or otherwise deter SHB infestation. Small hive beetles that do access the bee feed products may lay fewer eggs in the feed products compared to other feed products lacking blood meal. Small hive beetle eggs that are laid in the feed products of the present disclosure may not develop into pupae. As a result of reduced or prevented SHB infestation, bees may consume greater amounts of the bee feed products, resulting in improved bee colony health and survival.

Bees fed according to the methods herein may include honey bees from the Apidae family. Embodiments may involve feeding various species of bees, from the Apidae family or other families. In specific examples, the bees may comprise the western honey bee (Apis mellifera).

The infestation of SHBs may refer to the number of adult SHBs, SHB larvae, and/or SHB pupae found in the bee feed products or within bee colonies provided with the bee feed products. By eliminating or reducing SHB infestation, the bee feed products disclosed herein may reduce or eliminate one or more of the number of total SHBs, SHB larvae, or SHB pupae found in the feed products after a period of time ranging from about one day to about one week, or any period of time between one day and about one week. For example, after about 24 hours, each blood meal patty may harbor, on average, about 89.6% fewer SHB larvae than a similar bee feed patty lacking blood meal. The number of SHB larvae present on or within each blood meal patty after about 24 hours may be less than 1, while the number of SHB larvae typically present on a similar patty may be almost 4. Because bees may lose their attraction for a feed product about two days after SHB infestation, the reduction or elimination of SHB infestation caused by feeding the bees the feed products disclosed herein may increase the bees' level of feed intake and/or decrease a level of feed refusal. In some examples, providing the feed products may at least delay an onset of beetle infestation. Reduced or delayed infestation as provided herein means the amount of time infestation, if any, occurs is reduced compared to providing bee feed products that are free of blood meal but are otherwise formulated and fed the same as the bee feed products of the present disclosure. In some examples, providing the feed products may stop or slow SHB larval development, such that larvae may not develop or survive beyond the first instar stage of development. This effect may occur after as little as 24 hours, or between 24 and 72 hours in various embodiments.

A range of conditions may prompt feeding bees according to the methods described herein. Frequently, these conditions may involve low access to protein, e.g., pollen. In natural settings, e.g., unconfined outdoor areas, the amount of pollen available, as well as the content and quality of protein in the pollen may vary. As a result, the bee feed products described herein, which may be high in protein, may be provided to bees during pollen shortages and/or during periods where only low-quality and/or low-protein pollen is available. In unnatural, e.g., controlled and/or indoor settings, the bee feed products may be provided as part of an established, routine feeding regimen. Bees may also be provided with the bee feed products when colony strength is weak and/or when weather conditions restrict bee movement and pollen collection.

Generally, bees are fed in a group setting such as a colony. In some embodiments, the bees may be confined to cages, boxes or crates. In alternative embodiments, the bees may be unconfined and free to roam. Accordingly, the feeding methods disclosed herein may utilize a variety of feeding apparatuses placed in various locations. In some embodiments, the bee feed products may be placed directly on natural objects, e.g., plants, to provide the bees with feed products in their natural environment. In other embodiments, the bee feed products may be provided in one or more strategically-selected locations to stimulate movement of the bees as desired. In still other embodiments, the bee feed products may be placed in one or more locations where pollen sources are scarce. In addition, or alternatively, methods of feeding may incorporate apparatuses that visually emulate pollen-producing plants.

To form a feed patty, about 0.4 parts blood meal may be mixed with about 1.9 parts of the remaining patty components, which can include various feed components and one or more liquids, e.g., heavy sugar syrup, corn syrup and/or liquid sucrose. In embodiments, other ratios may be prepared, as described above. To scale up the amount and/or size of patties produced, the amount of blood meal and/or feed components mixed with liquid, for example, may be increased accordingly. For example, about 1 lb. of a feed and blood meal mixture may be combined with about 2.0 cups of syrup to produce about 2.3 lbs. of patties, about 5 lbs. of a feed and blood meal mixture may be combined with about 10 cups of syrup to produce about 11.5 lbs. of patties, about 20 lbs. of a feed and blood meal mixture may be combined with about 3.8 gallons of syrup to produce about 46 lbs. of patties, or about 40 lbs. of a feed and blood meal mixture may be combined with about 7.5 gallons of syrup to produce about 92 lbs. of patties. After combining the feed and blood meal mixture with the syrup, the components may be mixed thoroughly and assessed for desired consistency. In some examples, the feed and blood meal mixture may be mixed with the syrup at least 24 hours before providing the patties to bees. Because the mixture may continually absorb moisture, a user may add additional syrup to maintain a desired consistency. After mixing, a user may form the mixture into the desired patty size and shape.

Bees may be fed on an ad libitum basis in some embodiments. The total amount of feed provided for bees at any one time may vary depending on the number of bees being fed, the time of year, and/or the availability of other sources of artificial or natural pollen. In some embodiments, the feed products disclosed herein may comprise all or a portion of the bees' daily feed ration. In some embodiments, one bee colony may be provided with a single, one-pound (˜454 grams) feed patty on a weekly basis. At the end of each week, a fresh one-pound patty may be provided, regardless of whether the previously-provided patty is completely consumed. In some examples, the feed products may be replenished before the previously-provided products are consumed, such that the bees have constant access to the feed products. Accordingly, the frequency with which patties are replaced and the size of each patty may vary. In various embodiments, the amount of bee feed products consumed by the bees on a weekly basis may range from about 100 grams to about 750 grams, about 150 grams to about 700 grams, about 200 grams to about 650 grams, about 250 grams to about 600 grams, about 300 grams to about 550 grams, about 350 grams to about 500 grams, or about 400 grams to about 450 grams of the feed product per week. Until provided to bees, the bee feed products may be stored at reduced temperatures, e.g., at or below freezing, to preserve products not immediately consumed.

The bee feed products may be placed in close proximity to the bee colony. In embodiments, the feed products, e.g., patties, may be placed directly in the hive body. In other embodiments, the bee feed products may be held in bulk containers not within the columns/cages, especially if the products are not formed into patties, but rather provided as a paste or meal, for example. Feed products may be provided to the bees in a manner that reduces or minimizes disturbance of the bees. Placement of the feed products into a bee hive may cause the bees to release stress pheromones attractive to SHBs. Even though such pheromones may be released by the bees each time their feed supply is replenished, the bee feed products may not attract SHBs.

Over feeding periods ranging from about one day to about one week, the feed products may be generally less attractive to SHBs and may deter SHBs from laying eggs in the feed products. In a particular example, 24 hours after providing the feed patties to the bees, the number of SHB larvae present in or around the feed patties may be reduced compared to preexisting feed patties lacking blood meal. In some examples, the number of SHB larvae present within a single feed patty may be zero after 24 hours. In some examples, the number of SHB larvae present within a single feed patty may be zero after 48 hours. In additional examples, the number of SHB larvae present within a single feed patty may range from about zero to about one, or about zero to about two SHB larvae after 24 hours. Compared to preexisting feed patties lacking blood meal, the number of SHB larvae present within the blood meal-containing feed patties about 24 to 48 hours after feeding may be reduced by up to about 90%, or between about 85% and about 90%.

The methods disclosed herein may be used to feed adult bees, beginning immediately after emergence from the larval cell. In some embodiments, bees may be fed according to these methods beginning at about 0, 1, 2, 3, 4 or 5 or more days after emergence. Bees may continue to be fed according to these methods for the duration of their life span or for shorter, finite periods. Bees may be fed over the entirety of any of the aforementioned periods or for intermittent spans of time falling within or overlapping with these periods. Bees may be fed on a daily, weekly or monthly basis. Alternatively, bees may be fed irregularly and/or upon total consumption of the feed products.

In addition to the feed products containing blood meal, dry and/or liquid feed compositions containing high amounts of carbohydrates, e.g., sugar, may be fed concurrently to bees according to the methods disclosed herein. The amount of carbohydrate feed provided to bees may be adjusted according to activity levels. In some embodiments, the carbohydrate feed may be offered to the bees on an ad libitum basis.

Implementations of the present disclosure are more particularly described in the following bee trials for illustrative purposes only. Numerous modifications and variations are within the scope of the present disclosure as will be apparent to those skilled in the art.

### Example 1

This study was conducted in the spring of 2017 to assess the efficacy of a feed composition containing blood meal to deter SHB infestation. To accurately monitor SHB infestation and development, various larval stages, called “instars,” were monitored in test and control feed patties. An instar size range allows for visual identification of the level of development of the SHB.

Very small larvae (smaller than a grain of rice) were classified as first instar, small larvae (about the size of a grain of rice) were classified as second instar, medium-sized larvae (just slightly larger than a grain of rice) were classified as third instar, and large larvae (about 1 centimeter in length) were classified as fourth instar.

Test patties made up of a blood meal-containing feed composition and control patties comprised of a non-blood meal-containing feed composition, were placed inside honey bee colonies of similar size, such that each colony was provided with a test patty and a control patty. The feed composition of each patty comprised a high-protein supplement. The control patties were mixed from an existing commercially available supplement, the dry material containing no less than 38.3 wt % protein, 2 wt % fat, 8 wt % fiber, 3 wt % ash, and 10 wt % moisture. The components of the control patties comprised plant protein products, processed grain by-product, citric acid, potassium sorbate and sodium propionate (preservatives). After the control feed composition was mixed with syrup at a ratio of about 1:1 to form patties, corn syrup comprised about half of each control patty by weight, such that the final patty feed products contained about 19 wt % protein, about 1 wt % fat, about 4 wt % fiber, about 1.5 wt % ash, and about 20 wt % moisture.

The blood meal content of each test patty was about 18 wt %. The nutritional content of the dry feed composition used to create the test patties included about 56.0 wt % crude protein, about 3.0 wt % crude fat, about 3.0 wt % crude fiber, about 7.0 wt % moisture, about 0.4 wt % to about 0.9 wt % calcium, about 0.5 wt % phosphorus, about 0.51 wt % sodium, about 0.72 wt % sulfur, and about 0.90 mg/kg to about 1.08 mg/kg selenium. The specific components included in the dry feed composition used to create the test patties included grain distillers dried yeast, poultry blood, manganese sulfate, zinc sulfate, copper sulfate, wheat flour, isoleucine, salt, magnesium sulfate, L-tryptophan, potassium chloride, L-ascorbyl-2-polyphosphate (stabilized vitamin C), calcium sulfate, P-aminobenzoic acid, citric acid, nicotinic acid, vitamin A acetate, calcium iodate, vitamin E supplement, natural flavor, potassium sorbate (a preservative), artificial flavors, calcium pantothenate, thiamine mononitrate, calcium propionate (a preservative), vitamin B12 supplement, sodium molybdate, pyridoxine hydrochloride, riboflavin supplement, cholecalciferol (form of vitamin D3), choline chloride, menadione sodium bisulfite complex (source of vitamin K), folic acid, and biotin. To form test patties, the dry feed composition was mixed with syrup at a ratio of about 1.0 part feed composition to about 1.3 parts syrup.

All patties were collected from inside the bee colonies after 48 hours. The patties were then placed in individual containers within an incubator to allow larvae to further develop undisturbed by the bees for another 24 hours. After 24 hours, the patties were frozen to stop larval development. At this point, developing larvae were counted and sized using the conventional instar classification system.

None of the test patties were inoculated with larvae at the onset of the experiment, and wild populations of SHBs were relied upon to collect infestation data. To eliminate effects related to the bees' ability to ward off SHB infestation and/or the varying lengths of time needed for the SHBs to reach certain colonies, larvae were only counted in patties where larvae eventually appeared. In addition, only larvae that developed beyond the first instar were counted, as a typical SHB strategy is to lay a large clutch of eggs, and so it is common to have a high number of first instar larvae that may not necessarily develop further. Many larvae may move elsewhere or perish at that the first instar stage. Only larvae that were second instar and older were counted.

TABLE 1
Larval counts of SHB fed patties containing
or not containing blood meal

| | # of Larvae in | # of Larvae in |
|---|---|---|
| Colony No. | Blood Meal Patty | Blood Meal-Free Patty |
| 32 | 0 | 38 |
| 47 | 0 | 2 |
| 70 | 0 | 32 |
| 51 | 0 | 10 |
| 44 | 0 | 62 |

As shown in Table 1, employment of blood meal in a feed product, e.g., feed patty, for bees may prevent larval development in the feed product beyond the first instar, as none of the patties containing blood meal included larvae beyond the first instar stage, while all of the patties not containing blood meal included such larvae. Compared to an average of 0 larvae in the blood meal patties, the average number of larvae observed in each feed patty lacking blood meal was nearly 29. This difference in larval count between the two patty types was statistically significant (p<0.0001).

### Example 2

During the summer of 2016, three replicated trials were conducted to determine whether the inclusion of blood meal within a bee feed composition impacts the likelihood and/or severity of SHB infestation. By offering each group of test bees a different feed option, differing only by the protein source within each option, and observing the emergence of SHB larvae over the duration of the experiment, it was determined whether feed compositions containing blood meal were able to deter SHB infestation. In each trial, 24 bee colonies of similar size were each offered a commercially-available, negative control feed (i.e., no blood meal) or a blood meal-containing patty formulated as described above in Example 1. The colonies used in this study were located at three different sites at the Purina Animal Nutrition Center.

The commercially-available, negative control patties and the formulated blood meal patties were suitable for bees having little to no access to pollen, and may thus be considered protein supplement products or pollen substitute products. The commercially-available, negative control patties lacked any blood meal, and instead contained corn gluten meal, soy, and brewer's yeast as protein sources as indicated on the tag. By contrast, the blood meal patties lacked corn gluten meal and soy, and contained blood meal as the primary protein source. The blood meal patties, sourced from Purina, contained about 25 wt % protein. An amount of brewer's yeast was included in the blood meal patties for its bee attractant qualities.

The bees were housed in hives and the protein supplement patties were offered to the bees for a period of 24 hours. After 24 hours, the patties were removed from the cages and the SHB larvae located on or in the patties were counted. The larvae were totaled for all 12 colonies within each treatment group. The total larvae counts are shown below in Table 2.

TABLE 2
SHB larvae count after 24 hours in feed
patties containing or lacking blood meal

| Study No. | Containing Blood Meal | Not Containing Blood Meal |
|---|---|---|
| 1 | 1 | 8 |
| 2 | 13 | 19 |
| 3 | 0 | 108 |

As shown in Table 2, the total number of SHB larvae discovered in the negative control patties totaled 8, 19 and 108 for each study. Particularly in study 3 it is demonstrated how an infestation can overcome a patty. By contrast, the total number of SHB larvae discovered in the blood meal-containing patties totaled only 1, 13 and 0. Accordingly, an average larvae count of about 3.75 larvae per negative control patty were discovered when only negative control patties were offered to the bees. (Calculation: 8+19+108=135 total SHBL; 135/3 studies=45 SHBL per study; 45/12 colonies per treatment group, 1 patty per colony=3.75 SHBL/patty). By contrast, a lower average larvae count of less than 1 larva per blood meal patty was discovered when only blood meal patties were offered to the bees. (Calculation: 1+13+0=14 total SHBL; 14/3=4.67 SHBL per study; 4.67/12 colonies per treatment group, 1 patty per group=0.39 SHBL/patty). Thus, each blood meal patty, on average, contained about 89.6% fewer SHB larvae than the negative control patties lacking blood meal. In addition, fewer SHB larvae appeared in the blood meal patties versus the negative control patties within each study.

This experiment demonstrates that the blood meal patties consistently deterred to a greater extent, or were at least less vulnerable to, SHB infestation compared to the commercially available patties lacking blood meal. Even when feed patties containing blood meal were the only available substrates for the SHBs to lay eggs in, the SHBs still produced fewer larvae.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates, or use formulations; through inadvertent error in these procedures; through differences in the manufacture, source, or purity of starting materials or components used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of feeding bees, the method comprising:
providing a bee feed product to the bees on an ad libitum basis, wherein the bee feed product comprises an admixture of blood meal and a liquid bee feed,
wherein the amount of blood meal in the bee feed product reduces a level of beetle infestation.

2. The method of claim 1, wherein the bees increase consumption of the bee feed product in response to the reduced level of beetle infestation.

3. The method of claim 1, wherein the amount of blood meal comprises about 10 wt % to about 50 wt % of the bee feed product.

4. The method of claim 1, wherein the bee feed product comprises about 10 wt % to about 40 wt % protein.

5. The method of claim 1, wherein the bee feed product comprises about 20 wt % to about 30 wt % protein.

6. The method of claim 1, wherein the amount of blood meal comprises about 50 wt % to about 100 wt % of a total protein content of the bee feed product.

7. The method of claim 1, wherein the amount of blood meal comprises about 90 wt % to about 100 wt % of a total protein content of the bee feed product.

8. The method of claim 1, wherein the bee feed product is free of one or more of a corn gluten meal, soy, and egg powder.

9. The method of claim 1, wherein the bee feed product comprises a patty.

10. The method of claim 1, wherein the bees are adult bees.

11. The method of claim 1, wherein the bees are newly-emerged bees.

12. The method of claim 1, wherein the level of beetle infestation comprises an infestation of one or more small hive beetles after a period of about 24 hours.

13. The method of claim 1, wherein the bee feed product reduces a level of beetle infestation by one or more of: reducing a total number of beetles in the bee feed product compared to a preexisting feed composition lacking blood meal, preventing one or more beetles from infesting the bee feed product, reducing a number of beetle larvae in the bee feed product, reducing a number of beetle pupae in the bee feed product, or delaying an onset of a beetle infestation.

14. The method of claim 1, wherein providing the bee feed product comprises offering a new allotment of the bee feed product to the bees every week.

15. A method of feeding a bee colony in an area accessible to small hive beetles, comprising:
providing to the bee colony an amount of a bee feed product comprising nutrients including blood meal,
wherein the bee colony has ad libitum access to ingest the bee feed product for a time period;
wherein after the time period, the bee feed product is consumed by the colony to a greater extent and has a reduced level of beetle infestation compared to providing a bee colony with ad libitum access to the same amount of another bee feed product comprising the nutrients but which is free of blood meal.

16. The method of claim 15, wherein the amount of the bee feed product is one pound and the time period is one week.

17. A bee feed product comprising:
a bee feed liquid;
an amount of blood meal; and
a total protein content of about 10 to about 40 wt %, of which the amount of blood meal is a primary component by weight,
wherein the bee feed product is less susceptible to a beetle infestation compared to bee feed products lacking the amount of blood meal.

18. The bee feed product of claim 17, wherein the amount of blood meal comprises about 60 to about 100 wt % of the total protein content.

19. The bee feed product of claim 17, further comprising one or more food components comprising at least one of a flour, yeast, one or more oils, and one or more sugars.

20. The bee feed product of claim 17, wherein in response to being less susceptible to a beetle infestation, the bee feed product contains a smaller number of one or more beetles, beetle larvae,
or beetle pupae after about 48 hours of exposure in a feeding environment compared to a similar feed product lacking the amount of blood meal.
